(19) United States
(12) Patent Application Publication
(10) Pub. No.: US 2002/0194020 A1
(43) Pub. Date: Dec. 19, 2002

(54) Method for delivery of urologic devices and services

(76) Inventor: Thomas G. Hunter, Medford, MA (US)

Correspondence Address: Robert K. Tendler, 65 Atlantic Avenue, Boston, MA, 02110, US

(21) Appl. No.: 09/884,631

(22) Filed: Jun. 19, 2001

(51) Int. Cl. G06F 17/60

(52) U.S. Cl. 705/2; 705/26

(57) ABSTRACT

A method is provided for limiting the embarrassment of ordering medicines, medical services or medical devices and the like from ones bedside without the necessity of going into a doctors office, or pharmacy through the utilization of a handheld ordering device coupled to a cell phone or other wireless device in which a nurse or other person attending the patient keys in the patients record, the items requested, and billing information which is transmitted to a server. The server upon verification fulfills the bedside patient order by sending the requested devices to the patient in total privacy including instructions to permit either use by the patient or use by the care giver, such that the patient does not have to confront his or her embarrassment problems, while at the same time being a one step fulfillment and billing system which is wirelessly connected to the server. Additionally, bedside diagnosis and treatment can be administered from the server.

### FIELD OF INVENTION

This invention relates to the provision of medical services and more particularly to a method for providing a private order channel for a patient needing such services, or medicines.

### BACKGROUND OF THE INVENTION

As is common today with urologic patients not only is it necessary to order such things as diapers or other urine retaining devices to be used by the patient, there is also a necessity for assuring the privacy of such an ordering scheme. In most instances the patient must go to a pharmacy or some place outside of his normal private confines in order to do the device ordering, to pay for the devices, to obtain the instructions on how to use the devices, and to transport the devices back into his private domicile.

The problem with such a system or method is that the patient has to physically go to a pharmacy or like type store and confront an order taking individual, oftentimes being unsure of what is required. What ensues is a conversation which may be overheard by others in the facility, a situation which maybe embarrassing to the patient. For instance while it is possible to ask for diapers and the like, it is perhaps more embarrassing for the patient to ask for Texas catheters, straight catherers, skin care products, vaginal cones, pessaries, penile clamps, needle stimulators, wound care products, urine collection bags, commodes, gloves, vaginal and rectal sensors, and medications including colonurgics such as Ditropan®, Flomax®, Cardura®, Detrol®, and muscle relaxers and neuro-inhibitors such as acetylcholinas. Moreover, other urulogic medicines include anti-biotics, anti-spasmotics and anti-muscarinics.

Moreover, the pharmacy or other store may not have the item desired. The result is that the patient in some instances has to go from place to place in order to able to obtain that which is uniquely suitable for his or her needs. In short, there is no convient way or a less embarrassing way for the patient to obtain needed medical supplies, much less say single place at which the patient can obtain such supplies.

### SUMMARY OF THE INVENTION

In contradistinction, in the subject method, the patient is usually attended by a nurse or orderly who enters into a wireless device the patient's medical history, the precise item to be ordered, and billing information relative to the patient. The nurse, who already has a confidential relationship does not present a threatening or embarrassing presence to the patient and the patient is at ease with the obtaining of the needed medical devices or medication. All of this results in a private ordering channel for the patient which avoids embarrassment and encourages the patient to obtain required medical supplies

At bed side, or within the private domain of the patient, the nurse simply enters in the relevant information, transmits it to an incontinence device server, which is coupled to a fulfillment house for fulfilling the needs of the patient.

Urologic devices, information and medicines are then delivered to the patient's private domicile either by means of the mail, courier services or the like, with the devices being the right devices, and with the devices also including detailed instructions for the use of the patient and or the attending nurse or orderly. In addition to diapers, the urologic devices and medicines mentioned above may be delivered bed side or least directly to the patient without the patient having to go outside his private domicile. Moreover billing the patient is accomplished in one easy step, thus limiting paperwork associated with the ordering of various types of urologic devices and treatments.

This permits the utilization of a single incontinence device sever and fulfillment entity which can not only analyze the patient information and assure the appropriate device or medication is provided to the patient, but also can warehouse most commonly required urologic devices and medicines, with the fulfillment being one that is specially dedicated to urologic practice.

Additionally, with two way communication to the bedside such as through the internet, patient therapies can be delivered and controlled by the continence device server such therapies include biofeedback and electrical stimulation. Also, diagnostic procedures can be administered via the internet such as urodynamics and bladder volume measurement.

In summary, a method is provided for limiting the embarrassment of ordering medicines, medical services or medical devices and the like from ones bedside without the necessity of going into a doctors office, or pharmacy through the utilization of a handheld ordering device coupled to a cell phone or other wireless device in which a nurse or other person attending the patient keys in the patients record, the items requested, and billing information which is transmitted to a server. The server upon verification fulfills the bedside patient order by sending the requested devices to the patient in total privacy including instructions to permit either use by the patient or use by the care giver, such that the patient does not have to confront his or her embarrassment problems, while at the same time being a one step fulfillment and billing system which is wirelessly connected to the server. Additionally, bedside diagnosis and treatment can be administered from the server.

### BRIEF DESCRIPTION OF THE DRAWINGS

These and other features of the subject invention will be better understood in connection with the Detailed Description in conjunction with the Drawings, of which:

FIG. 1, is a diagrammatic representation of a private ordering channel for the use by an attending assistant in which ordering is done wirelessly through the utilization of a wireless phone to a cell site and then to a continence device server from which fulfillment proceeds;

FIG. 2, is a front view of a wireless order entry device of FIG. 1 in which various screens provide information to be entered by the attending assistant;

FIG. 3, is a diagrammatic representation of the screen of the entry device of FIG. 2, illustrating the entry of health insurance information;

FIG. 4, is a diagrammatic illustration of the screen of the entry device of FIG. 2, illustrating the presentation of an insurance authorization form and an assignment of benefits, with the patient being able to provide assent through signature on a touch sensitive screen;

FIG. 5, is a diagrammatic representation of the screen of the entry device of FIG. 2 showing the entry of new patient information;

FIG. 6, is a diagrammatic representation of the screen of the entry device of FIG. 2 showing a health history questionnaire;

FIG. 7, is a continuation of FIG. 6, in which the diagrammatic representation illustrates further patient history information to be inputted by the device of FIG. 2;

FIG. 8, is a further continuation of FIG. 6, illustrating information to be entered in accordance with the health history questionnaire; and, FIG. 9, is a continuation of FIG. 6 illustrating additional health history information to be entered in accordance with the health history questionnaire.

### DETAILED DESCRIPTION

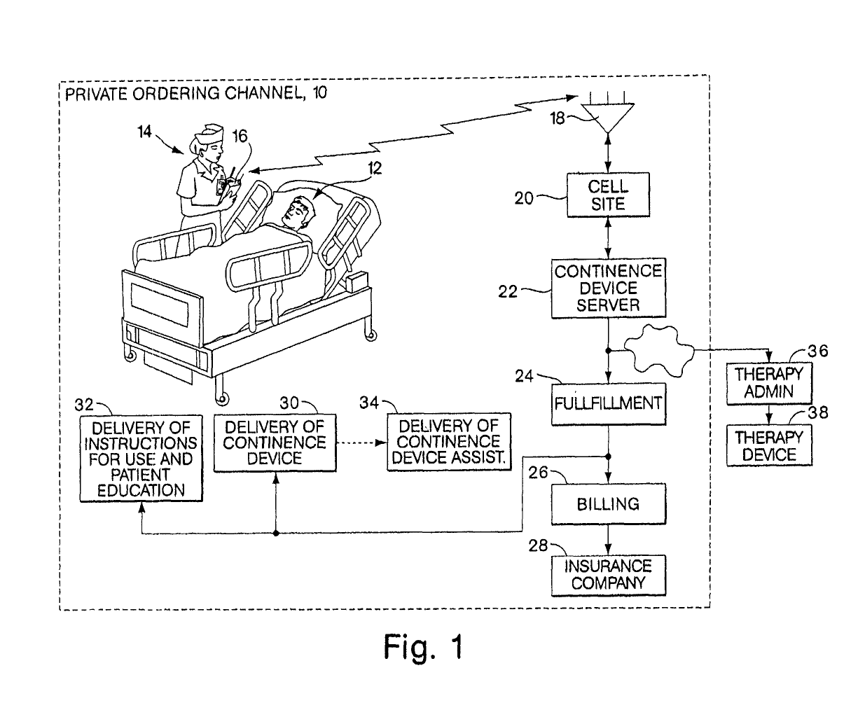

Referring now to FIG. 1, a private ordering channel 10 is depicted for a patient 12 in which services can be rendered to the patient in a completely private manner through an attending assistant 14 such as a nurse entering into an order entry device 16 various information which is necessary in order for the patient to obtain delivery of urologic devices, instructions and services.

Since the attending assistant 14 can do all of the ordering within the private confines of the patient's room or house, the delivery of the urologic or other services or devices is completely private between the patient and the attending person.

Order entry device 16 in general is a wireless communication device such as a cell phone which transmits the information to a cell phone tower 18 at a cell site 20 which in turn couples the information over a communications channel linked to a continence device/service/medicine server 22.

Continence device server 22 is utilized to receive the request from the entry device to correlate the request with a diagnosis of the patient, and to generate commands which result in the fulfillment 24 of the order placed by the device 16. The fulfillment function also includes a billing function 26 either direct to the patient or to an insurance company 28 while at the same time causing the system to deliver whatever continence devices as illustrated at 30 and/or instructions for use in patient education as illustrated at 32.

The delivery of continence devices or medications can arrive via courier from a fulfillment house, preferably in a plain wrapper to preserve privacy. As illustrated at 34, the delivery of urologic devices and services is not limited merely to the delivery to the bedside of such devices but can involve assistance either in computer generated form or elsewise to be able to utilize such continence devices and services. The delivery of continence device assistance can be delivered either to patient 12 or to the attending assistant 14 such that for instance procedures involving the insertion into body cavities of certain probes and devices can be described so that the patient can provide the necessary treatments at home, all under the assistance of the server 22.

Additionally, server 22 may directly through the internet, the internet or other communications channel control therapy administration as illustrated at 36 through a therapy device 38 delivered bedside to patient 12. This therapy administration and in fact the delivery of instructions in patient information as well as the delivery of continence treatment assistance can in fact be delivered over the internet or wirelessly via an appropriately configured wireless device 16 which not only serves as an order entry device but also as a 2-way communications channel.

The purpose of the ordering system described above is to provide complete ordering privacy for the urologic patient so that the urologic patient does not have to venture forth from his or her room or house and therefore interface with people with whom he is not familiar, thus avoiding certain embarassing situations mentioned above such as having to describe a problem to a pharmacist or other urologic device or service distributor or entity. Not only is privacy important to urologic patients, as part of the subject invention ordering and treatment of any medical condition which may prove embarrassing is within the scope of this invention.

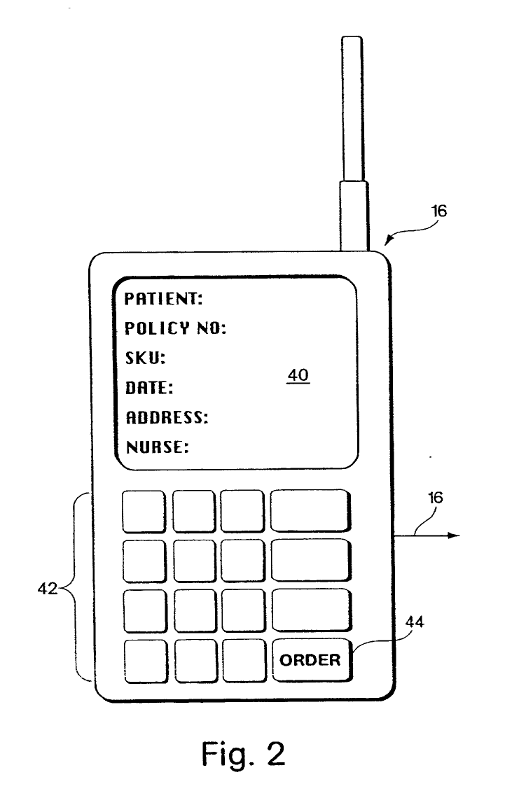

Referring now to FIG. 2, in one embodiment, ordering device 16 may be a wireless device including a screen 40 and keypad entry device 42 with a separate order button 44 being provided after the appropriate information has been entered into the screen.

Alternatively, the wireless device can be utilized to display instructions or patient education materials which rather than being delivered by courier or other means is delivered electronically through the wireless network. Additionally, therapy control signals can be supplied to the wireless device and thence outputted as illustrated by arrow 50 to control therapy device 38 of FIG. 1.

What has been described therefore is a private ordering and information delivery channel for urologic or other patients and thus to avoid embarrassment and potential non-use of corresponding devices and services.

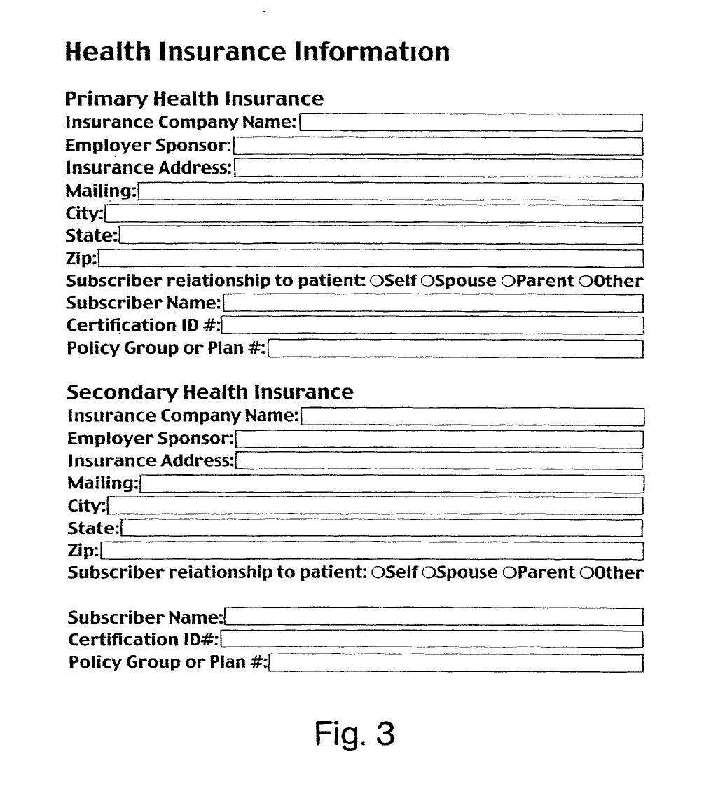

Referring to FIG. 3, as screen shot of what can be displayed at screen 40 of device 16 is shown in which basic health information is to be entered into device 16 such as for instance the insurance company name, the employee sponsor, the insurance address, the relationship to the patient, the subscriber's name, the certification identification, group plan number, and other secondary health insurance information.

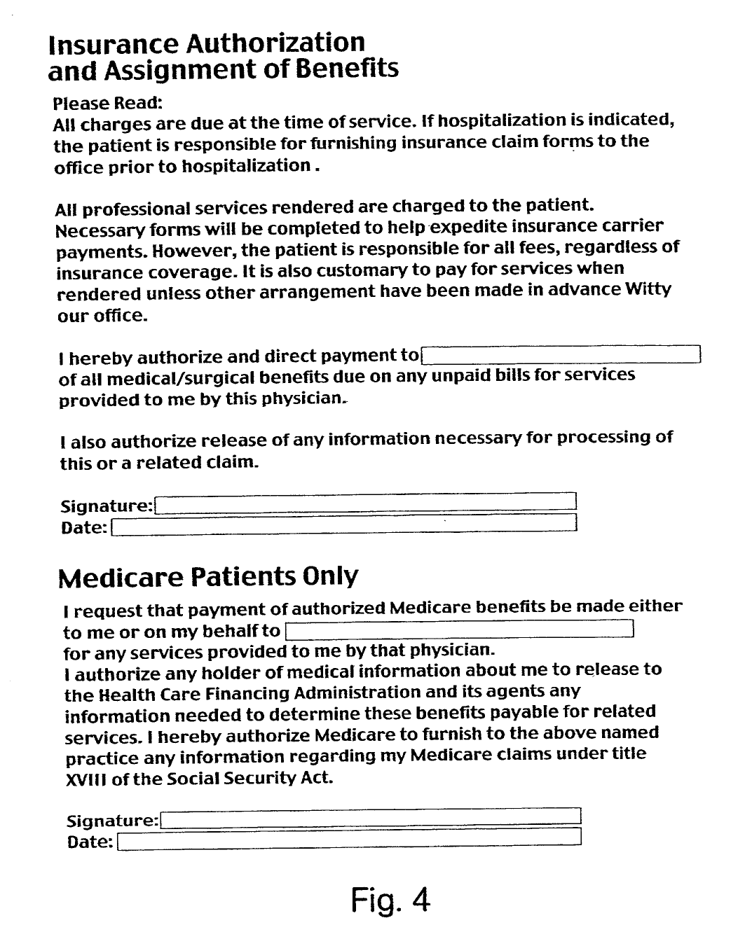

Referring to FIG. 4, what can be presented to the patient is an authorization screen which also includes assignment of benefits which, if the screen is provided with a touch sensitive portion can be utilized to record the patient's signature.

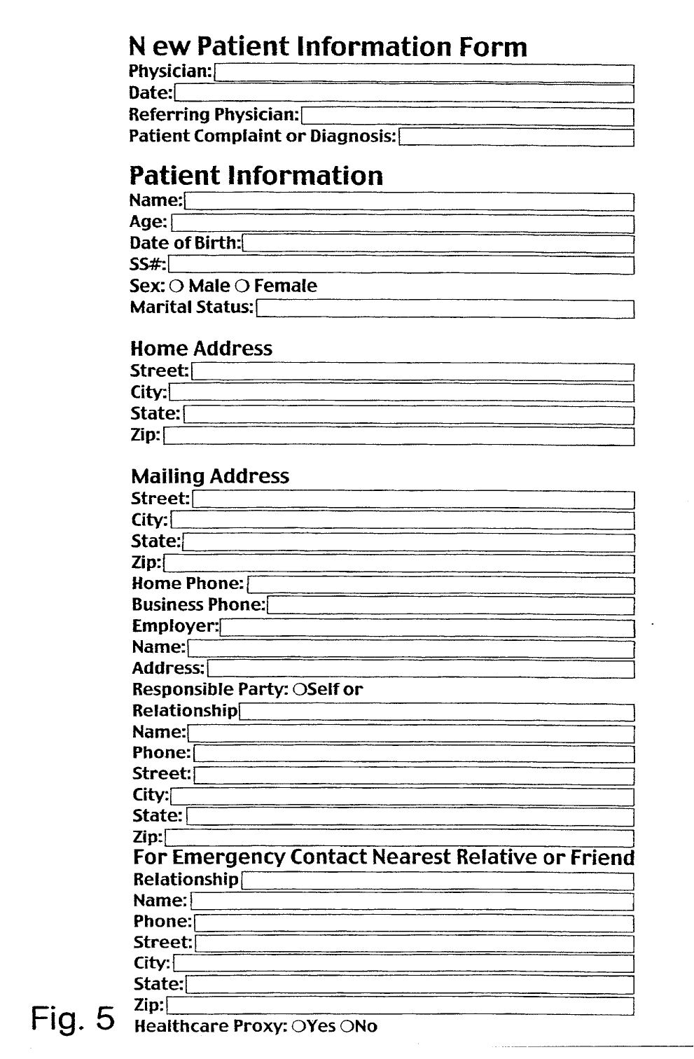

Referring to FIG. 5, screen 40 of device 16 of FIG. 2, may include a new patient information form which identifies the physician, the referring physician and the complaint and/or diagnosis. Also included is pertinent patient information such as name, age, sex, date of birth, social security number, marital status, addresses, phone numbers, employers, responsible parties and emergency contact information.

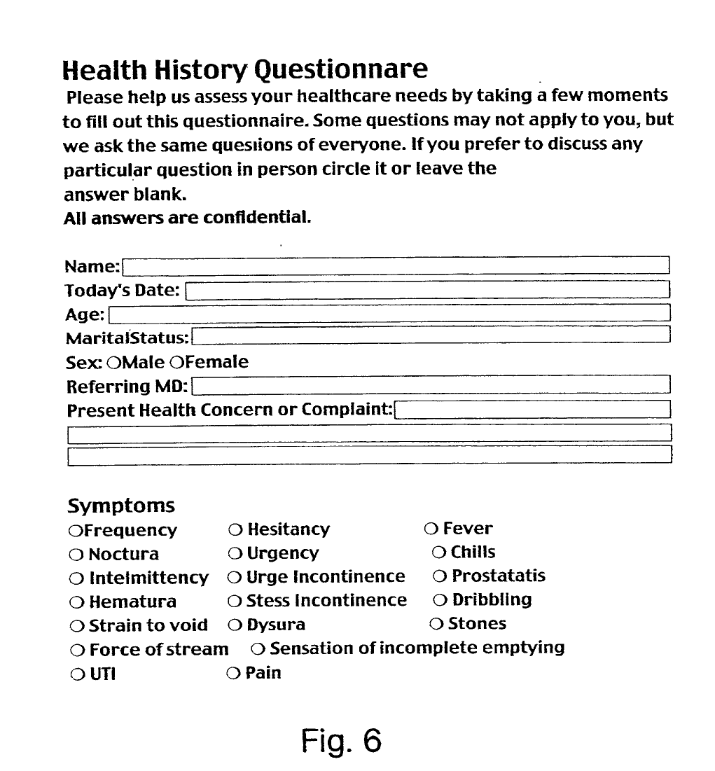

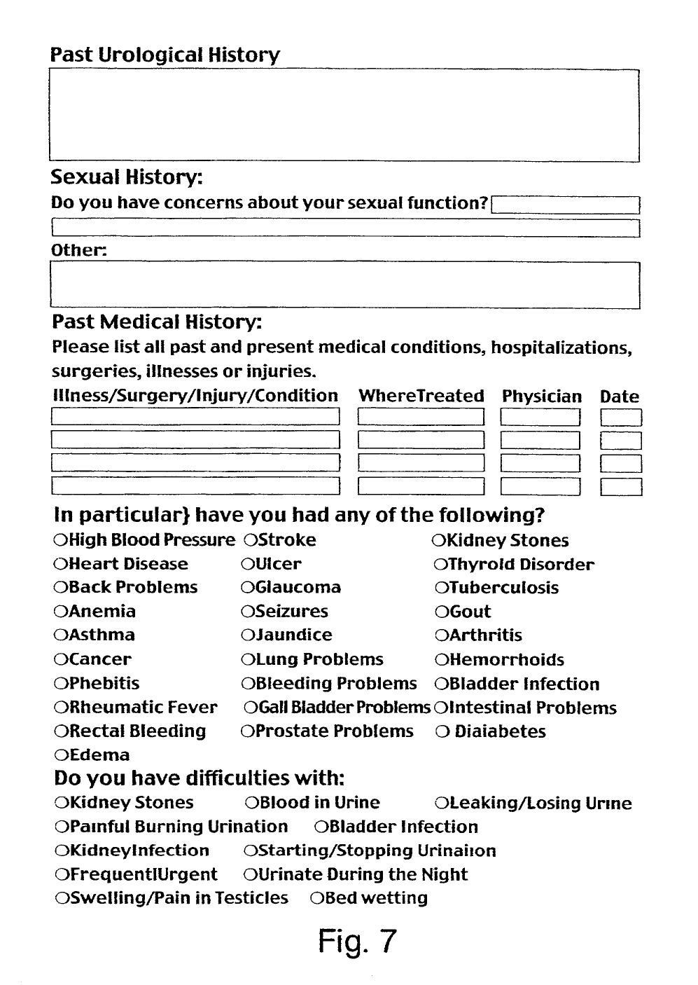

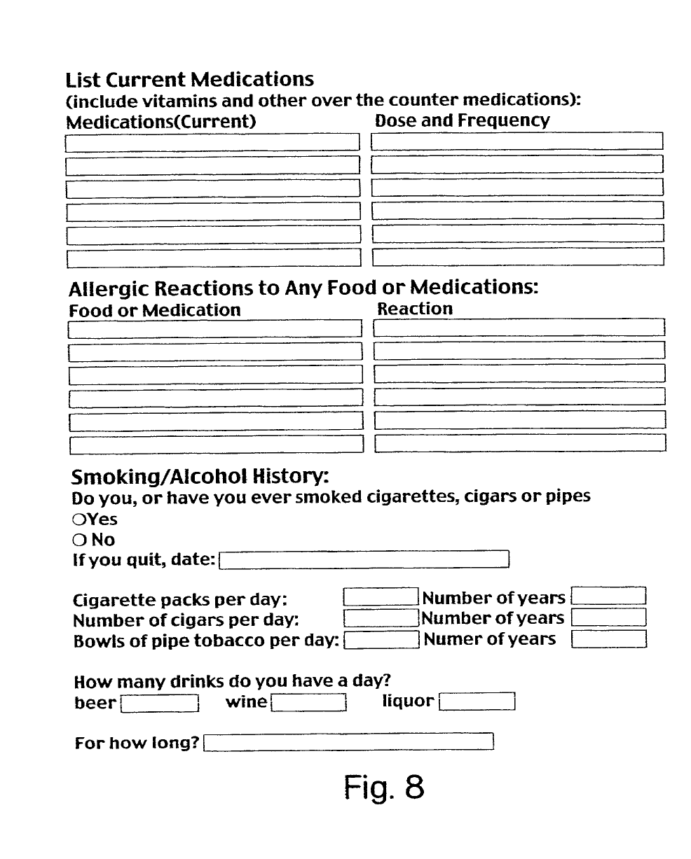

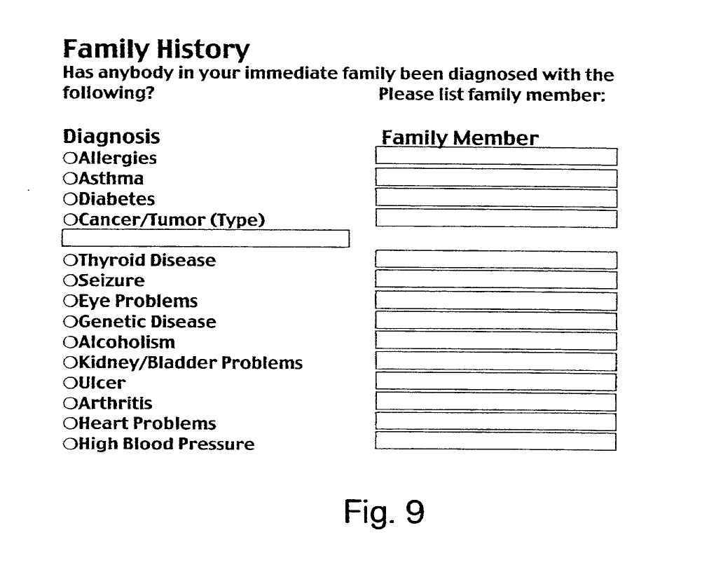

As illustrated in FIGS. 6-9, what is then presented to the patient on screen 40 of device 16 is a health history questionnaire which may be filled out by the attending person such as a nurse. The health history questionnaire screens are depicted in FIGS. 6-9 which include for instance, the name, the date, the age, the marital status, the sex, the referring physician, the present health concern symptoms, past urological history, sexual history, past medical history and indeed a list of conditions which can be indicated through the utilization of a touch screen or otherwise for the patient. Moreover, a list of current medications, allergic reactions and smoking and alcohol history can be entered at screen 40 as well as family history.

What will be appreciated is that the entire medical record and history for the individual patient can be entered at device 16 and transmitted to server 22 which can have built in certain ordering procedures and constraints based on analysis of the patient history forms. It can also have within it programs which assure that the ordered devices and services are appropriate with the patient history entered by device 16, thereby to minimize the chance of misdelivery of devices, services or medications.

What is therefore provided is a method for delivering medical devices, medicines and services in a completely private fashion through the utilization of a trusted individual such as a nurse at the bedside of the patient so that the patient does not have to move from his or bed or his or her confines in order to obtain the needed supplies, medicines and treatments.

By so doing, not only is the ordering procedure streamlined and promotes automatic billing, but also the patient is more likely to avail himself or herself of the needed or required devices and services as well as medications by eliminating from the patient's consideration any questions of privacy that are attendant with the patient going out to purchase such items or services or medications.

It will be appreciated that the information from the handheld device can be categorized in terms of diagnosis, treatment and products.

In operation, and referring now to diagnosis, it will be appreciated that a particular diagnostic procedure such as biofeedback may be inputted to the wireless device and the response of the patient to the diagnosis can be wirelessly transmitted to server 22.

The server 22 in one embodiment, analyses the raw data transmitted from the wireless device and produces a diagnosis, for instance that muscle function is impaired.

Upon diagnosis that muscle function is impaired, a treatment regime can be specified by the server with the treatment regime being both therapy, and requirement of urologic devices to be present at the bedside of the patient.

Upon ascertaining the treatment regime, and ascertaining what therapy, instructions, or devices are required, fulfillment 24 provides whatever is required to the patient's bedside either by virtue of delivery of physical devices and instructions to the patient or by the administration of therapy such as illustrated at 36 and therapy device 38 directly to the patient.

While what is pictured in FIG. 1 utilizes the internet to provide the information and signaling to permit therapy administration from a therapy device, likewise the continence device server can radio these same instructions wirelessly to device 16 so that therapy regimes can be wired directly to the wireless handset so that the therapy can be administered.

It will be appreciated that the programming of server 22 is diagnosis dependent, treatment dependent and medication/service/device dependent.

Alternatively, the wireless device may be used as a straight ordering instrument in which the attending person such as a nurse merely orders that which is necessary for the patient. In so doing, the wireless device having previously entered in billing information permits the fulfillment based on the on scene diagnosis by the attending person and appropriate billing, for instance to the insurance company.

For example, when there is urge incontinence, biofeedback is oftentimes utilized to assess muscle dysfunction.

How this dysfunction is measured may be by a probe inserted into the rectum, and means for transmitting an electrical impulse into the muscle while at the same time registering the response of the muscle to the impulse. This measurement is through the use of the rectally inserted probe.

Knowing the size of the stimulation and the response, a determination can be made at server 22 that there is detrusor instability. What this means is that the patient cannot control urinary leakage due to the inability of the muscles to contract sufficiently to prevent the leakage. One of the treatments that is called for upon such a diagnosis is treatment by electrical stimulation in which the rectally inserted probe is utilized along with the same stimulating electrodes. This is done by providing the appropriate signals from server 22 to hand held device 16, which is in turn, coupled to the appropriate probes and electrical stimulation apparatus. In this way, the patient does not have to move from his or her location and can be provided with the needed treatment.

Additionally, the patient may be provided with diapers, clamps, and other such devices to prevent leakage, which can be ordered through fulfillment 24 and delivered bedside. If the diagnosis indicates equipment that is not available bedside, then fulfillment 24 can provide such equipment to be sent bedside, at which point treatment can commence.

If it desired to utilize the internet as opposed to the wireless link for sending the appropriate signals for the treatment of the individual, then server 22 via the internet drives therapy administration unit 36 and therapy device 38 in much the same manner as devices coupled to the wireless communications device.

If on the other hand, the wireless device is merely utilized for ordering a product, medicines and/or services, then the entry of the information illustrated in FIGS. 3-9 may be utilized to confirm that which is ordered is appropriate for the patient. For instance, if Detrol® is ordered by the attending nurse in view of a physician's order, but assuming further that information about the patient entered at the device 16 is inconsistent with the diagnosis, then server 22 may have programming to inhibit the transmission or fulfillment of the particular order and to indicate an alarm condition. For instance, if Detrol®, which is utilized for treatment of non-prosthetic hyperplasia is not indicated because the particular patient's information indicates that the problem complained of is leakage, then the Detrol® would be an inappropriate medication for what the patient has complained of. Thus, server 22 can identify ordering requests which are inappropriate and provide an indication back to the ordering individual that the doctor must be contacted before authorization for the fulfillment of the particular request.

As part of the subject invention is a system for automatic billing based on information entered in by the wireless device. This automatic billing sequence which can in turn be routed to the insurance company or to some other financial institution is important in the timely delivery of devices, services or medicines.

What is therefore provided is a bedside wireless private ordering channel for any type of patient to alleviate the patient's embarrassment and to facilitate not only the delivery of the appropriate devices, services and medicines but also the authorization of the payment for the corresponding invoices.

Having now described a few embodiments of the invention, and some modifications and variations thereto, it should be apparent to those skilled in the art that the foregoing is merely illustrative and not limiting, having been presented by the way of example only. Numerous modifications and other embodiments are within the scope of one of ordinary skill in the art and are contemplated as falling within the scope of the invention as limited only by the appended claims and equivalents thereto.

What is claimed is

1. A method for limiting the embarrassment of having health care services provided to a patient in secure environs comprising the steps of:
providing a wireless channel from the patient to a server for the provision of information related to the health care service to be provided; and,
fulfilling the health care service responsive to the output from the server, whereby patient privacy is maintained without the patient having to move out of the secure environs.

2. The method of claim 1, wherein the health care service includes ordering of health care devices and the delivery thereof direct to the patient.

3. The method of claim 1, wherein the health care service includes delivery of information relative to the health care service direct to the patient.

4. The method of claim 1, wherein the health care service includes administering of a treatment under control of the server.

5. The method of claim 4, wherein the administering step includes sending signals from the server to the patient.

6. The method of claim 5, wherein the sending step includes utilization of the wireless channel.

7. The method of claim 5, wherein the sending step includes utilization of the Internet.

8. The method of claim 8, and further including the step of wirelessly obtaining authorization for the billing associated with the health care service.

9. The method of claim 1, and further including the step of the server ascertaining the appropriateness of the health care service requested.

10. The method of claim 9, and further including storing the diagnosis for the patient at the server and ascertaining the appropriateness of the health care service requested from the stored diagnosis.

11. The method of claim 1, wherein the health care services are taken from the group consisting of medical devices, medical information, medicines, medical procedures and medical treatments.
